(19) United States
(12) Patent Application Publication
(10) Pub. No.: US 2025/0332644 A1
(43) Pub. Date: Oct. 30, 2025

(54) SPINDLE DEVICE

(71) Applicant: JTEKT CORPORATION, Kariya-shi (JP)

(72) Inventors: Masaki ICHIKAWA, Kuwana-shi (JP); Tetsuro FURUHATA, Nagoya-shi (JP); Koji TOYAMA, Hekinan-shi (JP); Yuki MITSUDA, Kariya-shi (JP); Hiroaki GOSHIMA, Aisai-shi (JP)

(73) Assignee: JTEKT CORPORATION, Kariya-shi (JP)

(21) Appl. No.: 18/685,283

(22) PCT Filed: Sep. 21, 2022
(86) PCT No.: PCT/JP2022/035078

§ 371 Date: Aug. 15, 2024

(30) Foreign Application Priority Data
Sep. 28, 2021 (JP) 2021-157621
Jan. 18, 2022 (WO) PCT/JP2022/001553

(51) Int. Cl. B23B 31/26

(52) U.S. Cl. CPC B23B 31/265; B23B 2270/30

(57) ABSTRACT

A spindle device includes a main spindle having a tapered hole that is positioned at one end and to which a tool is removably attached, and a spindle cylindrical portion that is positioned on the other end side with respect to the tapered hole and communicates with the tapered hole, a collet chuck that is disposed inside the spindle cylindrical portion and grips the tool, and a drawbar that is connected to the other collet end of the collet chuck and moves the collet chuck forward and backward along an axial direction of the main spindle. The collet chuck includes a plurality of collet clearances that extends from one collet end forming one end and having an annular shape toward the other end of the main spindle, and forms channels that guide air to the tapered hole. The spindle cylindrical portion has a housing space in which the other collet end is housed in a clamped state. The main spindle includes a plurality of spindle air supply channels for supplying air to the housing space in an unclamped state. The spindle device further includes an annular channel that communicates upstream sides of the plurality of spindle air supply channels.

### TECHNICAL FIELD

The present disclosure relates to a spindle device.

### BACKGROUND ART

A main spindle of a spindle device used in a machine tool has a tapered hole into which a tool can be removably received. When the tool is removed, foreign matter such as swarf may be trapped in the inner circumferential surface of the tapered hole. Therefore, there is known a technology in which an air discharge hole is provided in the inner circumferential surface of the tapered hole and air is discharged from the air discharge hole to discharge the foreign matter. When air is discharged from the air discharge hole, however, the air may swirl in the circumferential direction of the tapered hole. When the air swirls, a negative pressure is created near the axis of the tapered hole, which may cause a suction phenomenon in which foreign matter is captured in the tapered hole. Therefore, in a spindle device of Patent Document 1, a straight flow discharge hole that discharges air flowing straight in the axial direction of the tapered hole is provided in addition to the air discharge hole (swirling flow discharge hole) provided in the tapered hole.

### RELATED ART DOCUMENTS

### Patent Documents

Patent Document 1: Japanese Unexamined Patent Application Publication No. 2021-88036 (JP 2021-88036 A)

### SUMMARY OF THE INVENTION

### Problem to be Solved by the Invention

In the spindle device of Patent Document 1, however, it is necessary to provide the straight flow discharge hole in addition to the swirling flow discharge hole, which may complicate the structure or control.

### Means for Solving the Problem

The present disclosure can be implemented as the following aspects.
(1) According to an aspect of the present disclosure, a spindle device is provided. This spindle device includes: a spindle housing: a main spindle rotatably supported by the spindle housing and having a tapered hole that is positioned at one end and to which a tool is removably attached, and a spindle cylindrical portion that is positioned on the other end side with respect to the tapered hole and communicates with the tapered hole: a collet chuck that is disposed inside the spindle cylindrical portion and grips the tool: and a drawbar that is connected to the other collet end of the collet chuck and moves the collet chuck forward and backward along an axial direction of the main spindle. The collet chuck includes: a plurality of claw portions that grips the tool and is arranged in a circumferential direction about a central axis of the main spindle: a plurality of collet clearances that extends from one collet end forming one end and having an annular shape toward the other end of the main spindle, forms channels that guide air to the tapered hole, and is each a clearance between claw portions among the plurality of claw portions: and a collet cam surface. The spindle cylindrical portion has a housing space in which the other collet end is housed in a clamped state. A defining surface that defines the housing space includes a cam surface that comes into contact with the collet cam surface when the collet chuck moves forward. The main spindle includes a plurality of air supply channels for supplying air to the housing space in an unclamped state. The spindle device further includes an annular channel that communicates upstream sides of the plurality of spindle air supply channels. According to this aspect, air supplied to the air supply channels temporarily remains in the housing space, passes from the housing space through the clearances between the spindle cylindrical portion and the collet outer circumference, flows through the collet clearances, and is discharged from the tapered hole. Since the air flows through the collet clearances and becomes a straight flow; it is possible to suppress the occurrence of a suction phenomenon near the axis of the tapered hole. According to this aspect, air can be supplied to the housing space from the plurality of air supply channels. Therefore, the air can be supplied to the plurality of collet clearances more uniformly. The spindle device includes the annular channel that communicates the upstream sides of the plurality of spindle air supply channels. The annular channel can achieve more uniform flow rates of air streams flowing into the plurality of spindle air supply channels. Therefore, it is possible to achieve more uniform flow rates of air streams that flow through the housing space and become the straight flows through the plurality of collet clearances. Since the air streams flowing out from the plurality of collet clearances are less likely to be biased, it is possible to further suppress the occurrence of the suction phenomenon near the central axis of the tapered hole.
(2) In the spindle device of the above aspect, a relative position of each collet clearance among the plurality of collet clearances with respect to each air supply channel among the plurality of air supply channels may be the same. According to this aspect, the path from the air supply channel to the collet clearance is substantially equal among all the air supply channels. Thus, the air streams discharged from the air supply channels are less likely to be biased, and the air easily flows straight through the tapered hole. Accordingly, it is possible to suppress the occurrence of the suction phenomenon.
(3) In the spindle device of the above aspect, the number of the plurality of collet clearances may be the same as the number of the plurality of air supply channels. The plurality of collet clearances may be disposed at equal intervals, and the plurality of air supply channels may be disposed at equal intervals. According to this aspect, the air discharged from the air supply channel is guided to the nearby air clearance for all the air supply channels. Thus, the air streams are less likely to be biased and the air flows straight. Accordingly, it is possible to suppress the occurrence of the suction phenomenon.
(4) In the spindle device of the above aspect, the plurality of air supply channels may extend along a radial direction of the main spindle. Phase positions of the plurality of air supply channels and phase positions of the plurality of collet clearances may agree with each other. According to this aspect, the air discharged from each air supply channel smoothly flows into the nearest collet clearance. Thus, disturbance of the flow of air is unlikely to occur. Accordingly, the air flows straight and the occurrence of the suction phenomenon can be suppressed.
(5) The spindle device of the above aspect may further include: a biasing member that biases the draw bar away from the tapered hole along the axial direction: and a cylinder device that pushes the draw bar toward the tapered hole in the unclamped state. According to this aspect, the present application can be applied to the spindle device including the biasing member and the cylinder device.
(6) The spindle device of the above aspect may further include: an inner pipe that is disposed inside the draw bar, and includes one pipe end forming one end, and the other pipe end closer to the other end of the main spindle than the one pipe end: a pipe air supply channel that is disposed outside the inner pipe and extends from the one pipe end to the other pipe end: an other-end air channel that is disposed near the other pipe end and causes air to flow into the pipe air supply channel, and through which the air flows inward in a radial direction of the inner pipe: a one-end air channel that is disposed near the one pipe end and causes air to flow out of the pipe air supply channel, and through which the air flows outward in the radial direction of the inner pipe: a guide sleeve disposed between the main spindle and the draw bar: a collet sleeve disposed between the main spindle and the drawbar to adjoin the guide sleeve in the axial direction: a third air supply channel that is formed by a clearance between the guide sleeve and the drawbar, and communicates with the one-end air channel: a guide sleeve channel that is formed at one end of the guide sleeve, extends along a radial direction of the guide sleeve, and communicates with the third air supply channel: a collet sleeve channel that is formed between the main spindle and the collet sleeve, communicates with the guide sleeve channel on the other end side, and communicates with the plurality of spindle air supply channels on one end side: and a coolant channel disposed inside the inner pipe. According to this aspect, the present application can be applied to the spindle device including the inner pipe, the pipe air supply channel, the guide sleeve channel, the collet sleeve channel, and the coolant channel.
(7) The spindle device of the above aspect may further include: an air communication channel that is formed on an outer side in a radial direction with respect to the spindle air supply channels, and through which air from an outside is supplied to the air supply channels: and a front bearing that is disposed at a position near the one end of the main spindle in the axial direction, and rotatably supports the main spindle. The air communication channel may include a one-end channel that is positioned on the one end side with respect to the front bearing in the axial direction, and is formed in the spindle housing and the main spindle. According to this aspect, the air communication channel including the one-end channel is formed on the outer side in the radial direction with respect to the spindle air supply channels. Therefore, complication of the configuration of the spindle device can be suppressed compared to a case where the air communication channel is formed on the inner side in the radial direction with respect to the spindle air supply channels in the main spindle, for example, in an axial hole of the main spindle. By forming the one-end channel in the spindle housing and the main spindle, there is no need to newly use another member for forming the one-end channel.
(8) In the above aspect, the spindle housing may include a first end face having a first opening constituting the one-end channel. The main spindle may include a second end face that has a second opening constituting the one-end channel, and faces the first end face in the axial direction. The one-end channel may include an axial channel that includes the first opening and the second opening, and extends in the axial direction. According to this aspect, the channel spanning the spindle housing that is a non-rotary element and the main spindle that is a rotary element can be formed as the axial channel.
(9) In the above aspect, the spindle housing may include a sleeve surrounding the main spindle about the axial direction. The sleeve may include an outer circumferential surface, the first end face, and a third end face protruding from the outer circumferential surface. The spindle housing may further include a fourth end face that faces the third end face in the axial direction. The spindle device may further include a sealer that is disposed between the third end face and the fourth end face, and is compressed in the axial direction in the unclamped state to bias the sleeve toward the second end face. According to this aspect, the first end face and the second end face come into close contact with each other. Thus, it is possible to suppress leakage of air to the outside from the axial channel.
(10) In the above aspect, the main spindle may further include a spindle cap forming the tapered hole. The spindle housing may further include a front cap constituting one housing end of the spindle housing. The one-end channel may be formed in the spindle cap and the front cap. According to this aspect, the spindle cap and the front cap can be assembled easily to the spindle device. Therefore, the one-end channel can be formed easily in the spindle device.
(11) In the above aspect, the main spindle may include: a cap small diameter portion positioned on a radially inner side of the spindle housing: and a cap large diameter portion that is positioned on the other end side with respect to the cap small diameter portion in the axial direction, and has a larger outside diameter than the cap small diameter portion. The second end face may be formed in the cap large diameter portion. According to this aspect, the second end face can be formed easily by using the cap large diameter portion of the spindle cap.
(12) The spindle device of the above aspect may further include: a biasing member that biases the drawbar away from the tapered hole along the axial direction: and a cylinder device that pushes the draw bar toward the tapered hole in the unclamped state. The first end face and the second end face may be separated from each other in the clamped state. The second end face may come into contact with the first end face in the unclamped state. According to this aspect, the first end face and the second end face come into contact with each other in the unclamped state. Therefore, the axial channel can be communicated.
(13) The spindle device of the above aspect may further include a retaining plate that is attached to the front cap, and includes the fourth end face. According to this aspect, the fourth end face can be formed by the retaining plate.
(14) In the above aspect, the spindle housing may include a one-end housing inner circumferential surface having an inner circumferential surface opening constituting the one-end channel. The main spindle may include a one-end spindle outer circumferential surface having an outer circumferential surface opening constituting the one-end channel. The outer circumferential surface opening may be disposed at a position where the outer circumferential surface opening faces the inner circumferential surface opening in the radial direction in the unclamped state. The one-end channel may include a radial channel that includes the inner circumferential surface opening and the outer circumferential surface opening, and extends in the radial direction in the unclamped state. According to this aspect, the channel spanning the spindle housing that is the non-rotary element and the main spindle that is the rotary element can be formed as the radial channel. The present disclosure can be implemented in various aspects, and can be implemented by, for example, a method for manufacturing the spindle device in addition to the spindle device described above.

### BRIEF DESCRIPTION OF THE DRAWINGS

FIG. 1 is a schematic diagram showing a longitudinal section of a spindle device.

FIG. 2 is an enlarged view of a region R2 in FIG. 1.

FIG. 3 is a perspective view of a collet chuck.

FIG. 4 is an enlarged sectional view of the collet chuck.

FIG. 5 is a diagram of the collet chuck that is viewed along a central axis.

FIG. 6 is a first schematic diagram showing a sectional view of a spindle device of a second embodiment.

FIG. 7 is a second schematic diagram showing the sectional view of the spindle device of the second embodiment.

FIG. 8 is a diagram showing a front part of the spindle device.

FIG. 9 is a schematic diagram showing part of the spindle device.

FIG. 10 is a diagram showing a rear part of the spindle device.

FIG. 11 is a diagram of a case where the spindle device is in an unclamped state.

FIG. 12 is a schematic diagram of part of the spindle device shown in FIG. 11.

FIG. 13 is a first diagram illustrating another embodiment of the second embodiment.

FIG. 14 is a second diagram illustrating the other embodiment of the second embodiment.

### MODES FOR CARRYING OUT THE INVENTION

### A. First Embodiment

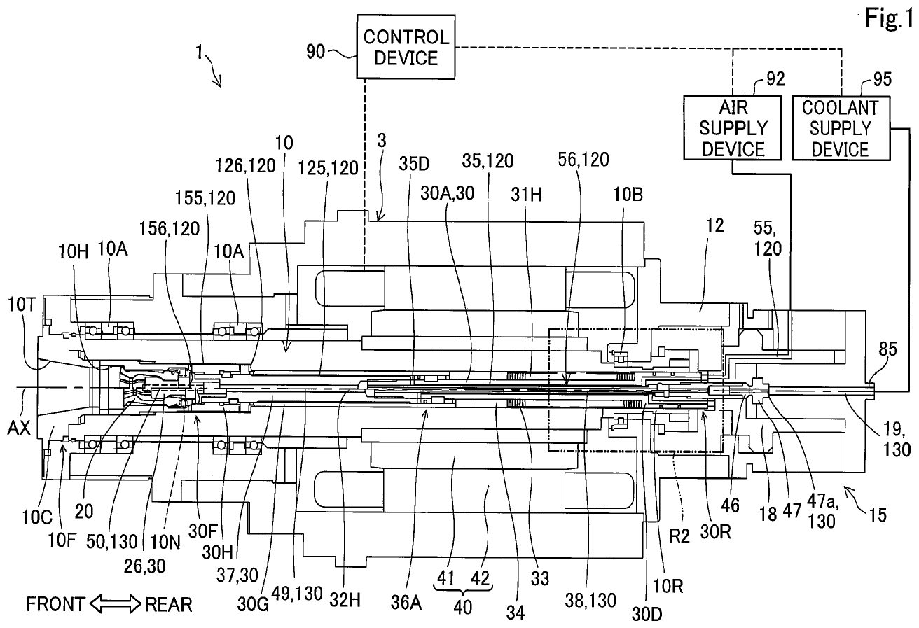

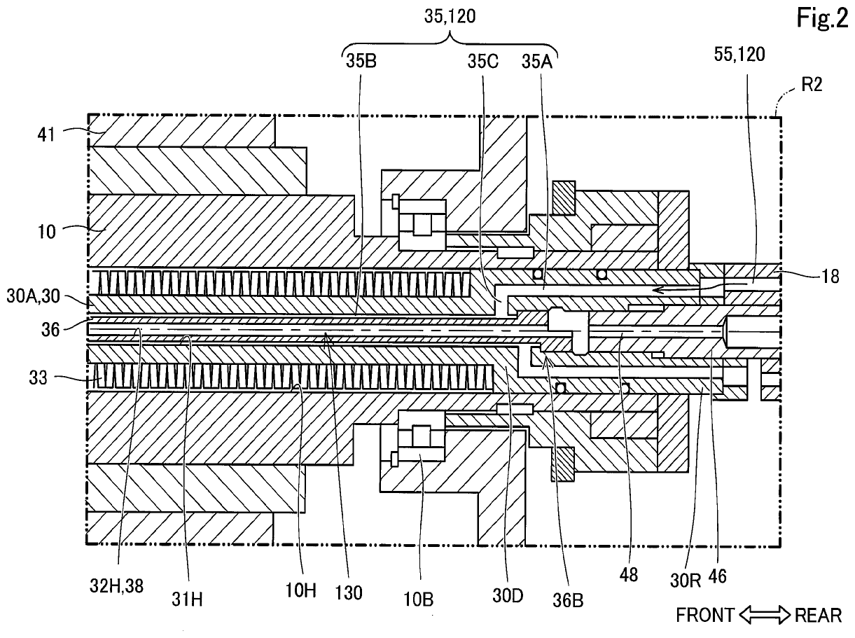

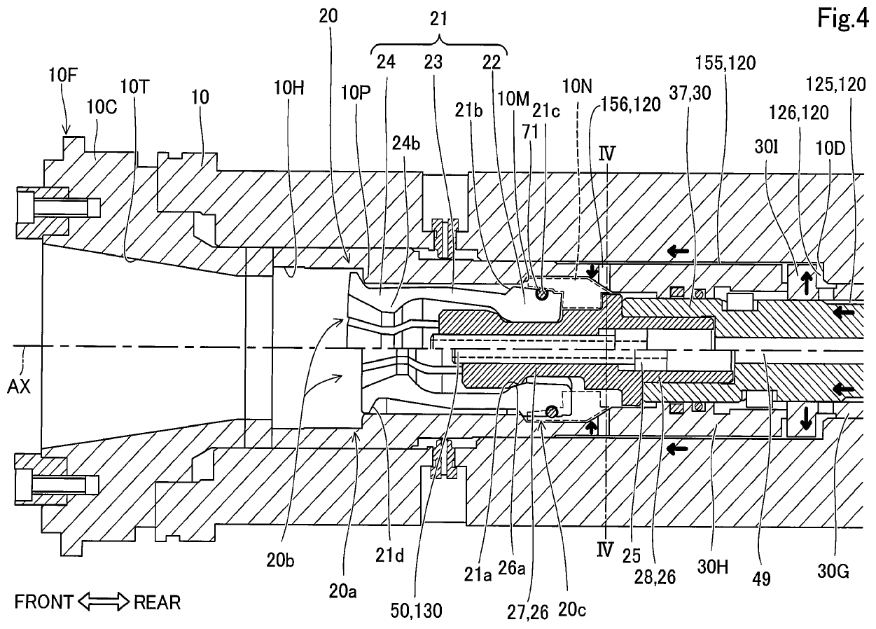

FIG. 1 is a schematic diagram showing a longitudinal section of a spindle device 1 of a first embodiment. FIG. 2 is an enlarged view of a region R2 in FIG. 1. The spindle device 1 of the present embodiment is a motor built-in spindle device provided in a machine tool such as a machining center. The spindle device 1 grips a tool for machining a workpiece on its front side. Specifically, the tool is implemented such that a machining tool is attached to a tool holder. FIG. 1 shows a central axis AX of a main spindle 10 of the spindle device 1. The figure in the upper half from the central axis AX shows an unclamped state in which the grip of the tool holder is released, and the figure in the lower half from the central axis AX shows a clamped state in which the tool holder is gripped. They are similarly shown in FIG. 4 described later. In an axial direction that is a direction along the central axis AX, the side where the tool is gripped is a front side, and the side opposite to the side where the tool is gripped is a rear side. The upper side of the drawing sheet of FIG. 1 is a vertically upward side, and the lower side of the drawing sheet is a vertically downward side.

The spindle device 1 includes a cylindrical spindle housing 3, the main spindle 10, a front bearing 10A, a rear bearing 10B, an electric motor 40, a drawbar 30, a collet chuck 20, a disc spring 33 serving as a biasing member, a cylinder device 15, and a control device 90. In the spindle housing 3, main elements of the spindle device 1 such as the main spindle 10 and the electric motor 40 are disposed inside.

The main spindle 10 is rotatably supported by the spindle housing 3 via two front bearings 10A and the rear bearing 10B. The main spindle 10 has the central axis AX, and rotates about the central axis AX by drive of the electric motor 40. The main spindle 10 has one end 10F that is a front end, and the other end 10R that faces the one end 10F. The main spindle 10 has a tapered hole 10T extending through the main spindle 10 in the axial direction, a spindle cylindrical portion 10H, and a spindle cap 10C. The tapered hole 10T is positioned at one end, that is, at the one end 10F of the main spindle 10, and a tool is removably attached. The spindle cylindrical portion 10H is positioned on the other end side, that is, on the other end 10R side of the main spindle 10 with respect to the tapered hole 10T. The spindle cylindrical portion 10H communicates with the tapered hole 10T.

The front bearing 10A is an angular rolling bearing disposed at a position on the front side with respect to the electric motor 40 in the axial direction. The two front bearings 10A are disposed away from each other in the axial direction. The front bearings 10A are interposed between the spindle housing 3 and the main spindle 10 in a radial direction of the main spindle 10 that is orthogonal to the axial direction. The rear bearing 10B is a roller type rolling bearing disposed at a position on the rear side with respect to the electric motor 40 in the axial direction. The rear bearing 10B is interposed between the spindle housing 3 and the main spindle 10 in the radial direction of the main spindle 10.

The electric motor 40 includes a rotor 41 and a stator 42. The electric motor 40 is disposed around the outer circumference of the main spindle 10 inside the spindle housing 3. The rotor 41 is rotatable together with the main spindle 10. The rotor 41 rotates by supplying electric power to the stator 42 under the control of the control device 90, thereby causing the main spindle 10 to rotate.

The collet chuck 20 is disposed inside the spindle cylindrical portion 10H. The collet chuck 20 moves forward and backward along the axial direction of the main spindle 10 in conjunction with the draw bar 30 so that the collet chuck 20 is in the clamped state in which a tool is gripped or the unclamped state in which the grip of the tool is released. Specifically, the collet chuck 20 is in the unclamped state when the drawbar 30 is pushed forward by the cylinder device 15 and moves toward one draw bar end 30F. The collet chuck 20 is in the clamped state when the draw bar 30 is separated from the cylinder device 15 and moves toward the other draw bar end 30R by a biasing force of the disc spring 33.

The drawbar 30 is disposed in the spindle cylindrical portion 10H. The draw bar 30 is connected to the collet chuck 20 and moves the collet chuck 20 forward and backward along the direction of the central axis AX of the main spindle 10. The draw bar 30 has the one draw bar end 30F positioned on the one end 10F side and the other draw bar end 30R positioned on the other end 10R side. The drawbar 30 is movable along the axial direction of the main spindle 10 by the operation of the cylinder device 15 described later. The draw bar 30 is connected to the main spindle 10 so as to operate in conjunction with a rotational operation of the main spindle 10.

The disc spring 33 is disposed between the inner circumferential surface of the main spindle 10 and the draw bar 30 in the spindle cylindrical portion 10H inside the main spindle 10. The disc spring 33 is disposed between a collar 34 disposed on the inner circumference of the main spindle 10 and a large diameter portion 30D formed at the other draw bar end 30R of the draw bar 30 in the axial direction of the main spindle 10. Specifically, the disc spring 33 is disposed so as to be inserted along the outer circumference of the draw bar 30. A plurality of disc springs 33 is provided along the axial direction. The rear end of the disc springs 33 is in contact with the large diameter portion 30D of the draw bar 30 on the other drawbar end 30R side while facing it in the axial direction. Therefore, the disc springs 33 apply a biasing force to the drawbar 30 in a direction in which the draw bar 30 moves away from the tapered hole 10T, that is, in a direction in which the drawbar 30 moves from the one end 10F side to the other end 10R side. With this biasing force, the collet chuck 20 is normally in the clamped state when the cylinder device 15 is not actuated. The disc spring 33 may be coated with grease to reduce a frictional force.

The cylinder device 15 is disposed on the rear side with respect to the draw bar 30 in the axial direction. The cylinder device 15 includes a piston 18 movable in the axial direction. The piston 18 faces the other drawbar end 30R of the draw bar 30 in the axial direction. When the piston 18 moves forward, the drawbar 30 moves forward by the piston 18 against the biasing force of the disc spring 33. This brings the collet chuck 20 into the unclamped state.

The control device 90 includes a CPU, a storage device, etc. and controls the operation of the spindle device 1. For example, the control device 90 controls the operation of the electric motor 40 of the spindle device 1.

The spindle device 1 further includes an air supply device 92 and a coolant supply device 95. The operations of the air supply device 92 and the coolant supply device 95 are controlled by the control device 90. The air supply device 92 is, for example, a compressor, and sends pressurized air into a channel provided in the piston 18 of the cylinder device 15. Specifically, the air supply device 92 stops supplying air in the clamped state, and supplies air in the unclamped state. The air supplied by the air supply device 92 in the unclamped state is supplied to the tapered hole 10T to remove swarf adhering to the tapered hole 10T. The coolant supply device 95 supplies a coolant to a coolant channel 130 extending in the axial direction through an opening 85 on the rear end side of the cylinder device 15. The coolant flows through the coolant channel 130 and is supplied to a machining point that is a cutting edge of the tool via the one draw bar end 30F and the inside of the tool.

As shown in FIG. 1, the drawbar 30 includes an outer circumferential drawbar 30A, a push rod 37, and a draw bolt 26. As shown in FIG. 2, an inner pipe 36 is disposed inside the outer circumferential drawbar 30A. Specifically, both ends of the inner pipe 36 protrude in a radially outward direction. Both the protruding ends of the inner pipe 36 are press-fitted into the inner circumference of the outer circumferential drawbar 30A. The large diameter portion 30D formed on the other drawbar end 30R side of the outer circumferential draw bar 30A is in contact with the disc springs 33. The outer circumferential draw bar 30A is a cylindrical member and has a first rod hole 31H extending through it in the axial direction. The inner pipe 36 is a cylindrical member and disposed in the first rod hole 31H, and has a second rod hole 32H extending through it in the axial direction. The inner pipe 36 has one pipe end 36A (FIG. 1) forming one end, and the other pipe end 36B that is closer to the other end 10R than the one pipe end 36A. The inner circumference of the push rod 37 is connected to the outer circumference of the outer circumferential draw bar 30A by screw fitting. The draw bolt 26 has a generally cylindrical shape. As shown in FIG. 4 described later, the other draw bolt end 28 that is the rear end of the draw bolt 26 is connected to the push rod 37 by screw fitting. As shown in FIG. 4 described later, the spindle device 1 further includes a guide sleeve 30G and a collet sleeve 30H. The guide sleeve 30G is disposed between the main spindle 10 and the draw bar 30. The collet sleeve 30H is disposed between the main spindle 10 (specifically, a spindle body) and the push rod 37. The collet sleeve 30H is disposed to adjoin the guide sleeve 30G in the axial direction. The guide sleeve 30G, the collet sleeve 30H, and the spindle cap 10C are sequentially fitted into the inner circumference of the main spindle 10, and the spindle cap 10C is fixed to the main spindle 10 (specifically, the spindle body) with bolts. The guide sleeve 30G and the collet sleeve 30H are fixed to the main spindle 10 (specifically, the spindle body) by being sandwiched between a stepped portion 10D of the main spindle 10 and the spindle cap 10C in the axial direction. The spindle cap 10C, the guide sleeve 30G, and the collet sleeve 30H rotate together with the spindle body and constitute the main spindle 10.

Next, configurations related to various channels in the spindle device 1 will be described with reference to FIGS. 1 and 2. Regarding the various channels, the reference for “upstream” and “downstream” is based on a flow direction of a fluid supplied from each of the air supply device 92 and the coolant supply device 95. The spindle device 1 includes the coolant channel 130 (FIGS. 1 and 2) through which the coolant is supplied to the machining point for machining with the tool gripped by the collet chuck 20, and an air supply channel 120 (FIGS. 1 and 2) through which air to be blown into the tapered hole 10T is supplied to the tapered hole 10T.

The coolant channel 130 includes a first coolant channel 19 (FIG. 1) formed in the cylinder device 15, a fourth coolant channel 47a (FIG. 1) formed in a fixed joint 47, a second coolant channel 48 (FIG. 2) formed in a rotary joint 46, a third coolant channel 38 (FIGS. 1 and 2) formed in the inner pipe 36, a fifth coolant channel 49, and a sixth coolant channel 50. As shown in FIG. 2, the third coolant channel 38 serving as the coolant channel is disposed inside the inner pipe 36 and formed by the second rod hole 32H of the inner pipe 36. As shown in FIG. 1, the fifth coolant channel 49 is disposed inside the push rod 37. The sixth coolant channel 50 is disposed inside a cylindrical spool 25 (FIG. 4) disposed inside the draw bolt 26. The coolant supplied from the coolant supply device 95 flows through the first coolant channel 19, the fourth coolant channel 47a, the second coolant channel 48, the third coolant channel 38, the fifth coolant channel 49, and the sixth coolant channel 50 in this order and is supplied to the machining point that is the cutting edge of the tool positioned on the one end 10F side via the inside of the tool. Thus, the coolant channel 130 is a channel formed along the axial direction. The coolant supply device 95 supplies the coolant to the coolant channel 130 during a period in which the main spindle 10 is rotating in the clamped state in response to a command from the control device 90.

The air supply channel 120 includes an upstream air supply channel 55 (FIGS. 1 and 2) formed in a non-rotary element of the spindle device 1, and a downstream air supply channel 56 (FIG. 1) positioned downstream of the upstream air supply channel 55 and formed in a rotary element of the spindle device 1. The upstream air supply channel 55 is formed in the piston 18 that is the non-rotary element. The upstream air supply channel 55 is also referred to as a first air supply channel 55. The downstream air supply channel 56 includes a second air supply channel 35 (FIGS. 1 and 2) formed inside the draw bar 30 and between the draw bar 30 and the inner pipe 36, a third air supply channel 125 (FIG. 1) formed by a clearance between the main spindle 10 and the drawbar 30, a sixth air supply channel 126 (FIG. 1) serving as a guide sleeve channel, a fourth air supply channel 155 (FIG. 1) formed inside the main spindle 10 and serving as a collet sleeve channel, and a spindle air supply channel 156 (FIG. 1).

As shown in FIG. 2, the downstream end of the first air supply channel 55 is an opening formed in the piston 18 at a position where the first air supply channel 55 faces the draw bar 30 in the axial direction. When the end faces of the piston 18 and the draw bar 30 come into contact with each other in the unclamped state, the first air supply channel 55 in the piston 18 is connected to the second air supply channel 35 in the draw bar 30. The second air supply channel 35 includes an upstream channel 35A, an other-end air channel 35C, a downstream channel 35B, and a one-end air channel 35D (FIG. 1) that are formed in the outer circumferential draw bar 30A. The downstream channel 35B serving as a pipe air supply channel is formed by a clearance between the inner circumferential surface of the outer circumferential draw bar 30A and the outer circumferential surface of the inner pipe 36. The downstream channel 35B is disposed outside the inner pipe 36 and extends from the one pipe end 36A to the other pipe end 36B. The downstream channel 35B communicates with a plurality of spindle air supply channels 156 described later. The other-end air channel 35C is located between the upstream channel 35A and the downstream channel 35B. The other-end air channel 35C is disposed near the other pipe end 36B. The other-end air channel 35C extends in the radial direction of the inner pipe 36. Air flows through the other-end air channel 35C inward in the radial direction of the inner pipe 36 and flows into the downstream channel 35B. The one-end air channel 35D (FIG. 1) is located between the downstream channel 35B and the third air supply channel 125. The one-end air channel 35D is disposed near the one pipe end 36A. The one-end air channel 35D extends in the radial direction of the push rod 37 and the outer circumferential draw bar 30A. The air flows through the one-end air channel 35D outward in the radial direction of the push rod 37 and the outer circumferential draw bar 30A and flows out into the third air supply channel 125.

As shown in FIG. 1, the third air supply channel 125 is formed by a clearance between the guide sleeve 30G and the push rod 37. The third air supply channel 125 communicates with the second air supply channel 35. As shown in FIG. 4 described later, the guide sleeve 30G includes, at one end, a large diameter portion 30I that protrudes in the radially outward direction. The large diameter portion 30I is in contact with the stepped portion 10D of the main spindle 10. The fourth air supply channel 155 is formed between the inner circumference of the main spindle 10 and the outer circumference of the large diameter portion 30I. The sixth air supply channel 126 is formed in the large diameter portion 30I on the stepped portion 10D side of the main spindle 10. The sixth air supply channel 126 is formed in the large diameter portion 30I of the guide sleeve 30G on the stepped portion 10D side and extends in the radial direction of the large diameter portion 30I. The sixth air supply channel 126 connects the third air supply channel 125 and the fourth air supply channel 155. The fourth air supply channel 155 is a channel having an annular shape (annular channel) about the central axis AX and formed between the inner circumference of the main spindle 10 and the outer circumference of the collet sleeve 30H. The upstream end, that is, the other end side of the fourth air supply channel 155 is connected to the third air supply channel 125 via the sixth air supply channel 126, and the downstream end, that is, the one end side of the fourth air supply channel 155 is connected to the upstream end of the spindle air supply channel 156. Specifically, a plurality of spindle air supply channels 156 is provided and the fourth air supply channel 155 that is the annular channel communicates the upstream ends of the plurality of spindle air supply channels 156 with each other. The downstream ends of the spindle air supply channels 156 are open to the spindle cylindrical portion 10H as described in detail later.

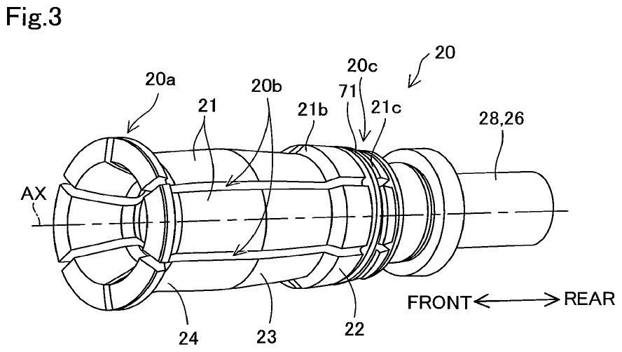

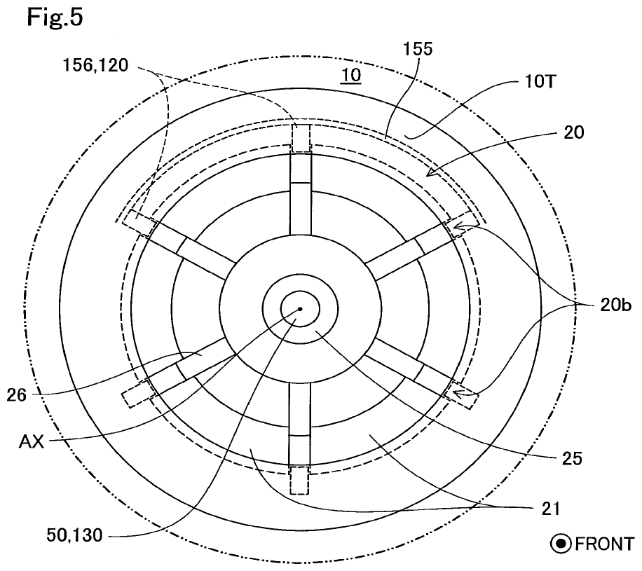

FIG. 3 is a perspective view of the collet chuck 20 and the draw bolt 26. FIG. 4 is an enlarged sectional view of the collet chuck 20 and the draw bolt 26 in the unclamped state. In FIG. 4, the flows of air are indicated by arrows. FIG. 5 is a diagram of the collet chuck 20 in the unclamped state that is viewed from the front along the central axis AX. In FIG. 5, the inner circumference of the main spindle 10 and the outer circumference of the collet sleeve 30H along the line IV-IV shown in FIG. 4 are represented by dashed lines. The front and rear directions shown in FIGS. 3 to 5 are the same as the directions shown in FIG. 1. As shown in FIG. 3, the collet chuck 20 has one collet end 20a forming one end and having an annular shape, a plurality of collet clearances 20b, and the other collet end 20c forming the other end. As shown in FIG. 4, the one collet end 20a is disposed closer to the tapered hole 10T than the other collet end 20c. As shown in FIG. 3, the plurality of collet clearances 20b extends from the one collet end 20a toward the other end 10R (FIG. 1) that is the other end of the main spindle 10. The plurality of collet clearances 20b forms channels that guide air to the tapered hole 10T.

As shown in FIG. 3, the collet chuck 20 includes collet claws 21 serving as a plurality of claw portions. In the present embodiment, the collet chuck 20 includes six collet claws 21. The plurality of collet claws 21 is attached to the outer circumferential surface of one draw bolt end 27 that is the front end of the draw bolt 26 so as to surround the entire circumference of the one draw bolt end 27 (FIG. 4). The spool 25 is disposed inside the draw bolt 26. The spool 25 is slidably fitted into the draw bolt 26.

As shown in FIG. 3, the collet claws 21 generally have a shape obtained by dividing a cylinder into six parts on planes along the central axis of the cylinder. The collet claw 21 has a shape extending along the central axis AX of the collet chuck 20. The collet claw: 21 includes a collet base 22, a collet cylindrical portion 23, a collet tip 24, a claw slope 21a (FIG. 4), a first claw cam surface 21b serving as a collet cam surface, a collet recess 21c, and a second claw cam surface 21d. The collet base 22 is the rear end of the collet claw 21. The collet tip 24 is the front end. The collet cylindrical portion 23 is positioned between the collet base 22 and the collet tip 24. The thickness of the collet base 22 is larger than the thickness of the collet cylindrical portion 23. The inner circumferential surface of the collet base 22 protrudes more inward than the inner circumferential surface of the collet cylindrical portion 23. On the inner circumferential surface of the collet claw 21, the claw slope 21a is provided at the boundary between the collet base 22 and the collet cylindrical portion 23. The outer circumferential surface of the collet base 22 protrudes more outward than the outer circumferential surface of the collet cylindrical portion 23. On the outer circumferential surface of the collet claw 21, the first claw cam surface 21b is provided at the boundary between the collet base 22 and the collet cylindrical portion 23. The claw slope 21a and the first claw cam surface 21b are surfaces inclined with respect to the central axis AX. The tip of the outer circumferential surface of the collet tip 24 protrudes toward the main spindle 10 with respect to the outer circumferential surface of the collet cylindrical portion 23. The second claw cam surface 21d is provided on the outer circumferential surface of the collet tip 24. The second claw cam surface 21d is part of a surface that connects the protruding tip of the collet tip 24 and the collet cylindrical portion 23. The second claw cam surface 21d is inclined with respect to the central axis AX. An inner circumferential protrusion 24b that protrudes toward the central axis AX with respect to the inner circumferential surface of the collet cylindrical portion 23 is formed on the inner circumferential surface of the collet tip 24. The inner circumferential protrusion 24b engages with a pull stud of the tool (not shown).

The collet recess 21c is formed on the outer circumferential surface of the collet base 22 so as to recede inward. The plurality of collet claws 21 is pressed against the draw bolt 26 by winding a coil spring 71 around the collet recesses 21c. The plurality of collet claws 21 is fixed away from each other in the circumferential direction. A key structure (not shown) is formed on the plurality of collet claws 21 and the draw bolt 26 so that they are fitted to each other. Therefore, the plurality of collet claws 21 is prevented from rotating relative to the one draw bolt end 27. The clearance between two adjacent collet claws 21 is the collet clearance 20b.

As shown in FIG. 4, the draw bolt 26 has a bolt slope 26a formed at a position where it faces the claw slopes 21a. The collet sleeve 30H has a spindle cam surface 10M serving as a cam surface that faces the first claw cam surfaces 21b in the clamped state. The bolt slope 26a and the claw slopes 21a are in contact with each other. Therefore, the pull stud of the tool (not shown) is held by the inner circumferential protrusions 24b of the collet claws 21. When the drawbar 30 moves forward, the first claw cam surfaces 21b and the spindle cam surface 10M come into contact with each other. The collet claws 21 then make transition from the form in the clamped state to the form in the unclamped state. Therefore, the inner circumferential protrusions 24b of the collet claws 21 are opened radially outward from the pull stud of the tool (not shown). The collet sleeve 30H has a spindle protrusion 10P formed at a position where it faces the second claw cam surfaces 21d. The spindle protrusion 10P is a portion of the spindle cylindrical portion 10H that protrudes radially inward with respect to the end adjacent to the tapered hole 10T. When the draw bar 30 moves rearward, the second claw cam surfaces 21d and the spindle protrusion 10P come into contact with each other. The collet claws 21 then make transition from the form in the unclamped state to the form in the clamped state.

As shown in FIGS. 1 and 4, a housing space 10N of the main spindle 10 is a space in which the collet bases 22 are housed in the clamped state. As shown in FIG. 4, the spindle cam surface 10M is a defining surface that defines the housing space 10N. The fourth air supply channel 155 extends along the direction of the central axis AX. The spindle air supply channels 156 extend along the radial direction of the main spindle 10. The downstream ends of the spindle air supply channels 156 are open to the housing space 10N.

As shown in FIG. 5, the plurality of spindle air supply channels 156 is provided away from each other in the circumferential direction of the main spindle 10. The spindle air supply channels 156 are provided in association with the collet clearances 20b. In the present embodiment, the number of the spindle air supply channels 156 is six that is the same as the number of the collet clearances 20b. The internal space of the spool 25 is the sixth coolant channel 50 through which the coolant flows. The plurality of collet clearances 20b is disposed at equal intervals in the circumferential direction. The plurality of spindle air supply channels 156 is disposed at equal intervals in the circumferential direction. That is, the relative position of each of the six collet clearances 20b with respect to one spindle air supply channel 156 is the same for all the spindle air supply channels 156. The phase positions of the plurality of air supply channels 120 and the phase positions of the plurality of collet clearances 20b agree with each other. The phase position is a position in the circumferential direction of the main spindle 10.

When attaching the tool, the tool is inserted into the internal space of the collet chuck 20 and the draw bar 30 moves rearward. In conjunction with this, the collet chuck 20 moves rearward and grips the tool while being deformed so as to tighten the pull stud of the tool. When removing the tool for tool replacement, the draw bar 30 moves forward. In conjunction with this, the collet chuck 20 moves forward and the inner circumferential surface of the collet chuck 20 is deformed away from the pull stud of the tool. The tool is pulled forward and a new tool is inserted.

When the tool is pulled for tool replacement, air is discharged toward the tapered hole 10T to suppress adhesion of swarf generated during machining to the tapered hole 10T. When the discharged air swirls in the circumferential direction of the tapered hole 10T, a negative pressure is created near the axis of the tapered hole 10T, which may cause a suction phenomenon in which swarf is captured in the tapered hole. When the suction phenomenon occurs, there is a possibility that the captured swarf adheres to the tapered hole 10T to reduce the tool attachment accuracy. Therefore, the inventors have devised a method so that the air is a straight flow that travels straight along the central axis AX. Thus, swirling of air can be suppressed and the suction phenomenon can be suppressed. Accordingly, the degree of cleaning of the tapered hole 10T can be improved and the tool attachment accuracy can be improved. Specifically, in the present embodiment, the spindle air supply channels 156 are open to the housing space 10N. Therefore, the air discharged from the spindle air supply channels 156 temporarily remains in the housing space 10N and flows from the housing space 10N toward the tapered hole 10T. Thus, the bias in the flow is reduced compared to a structure in which the air flows directly into the tapered hole 10T without passing through the housing space 10N. Accordingly, the air can become a straight flow. In the present embodiment, the air is supplied to the tapered hole 10T through the collet clearances 20b extending in the axial direction from the housing space 10N. Since the air flows along the collet clearances 20b, the air flowing out into the tapered hole 10T can become a straight flow:

In the present embodiment, the plurality of spindle air supply channels 156 is provided. Therefore, it is possible to suppress unevenness in the distribution of the air supplied to the housing space 10N. Thus, the air can uniformly be supplied to the plurality of collet clearances 20b. In the present embodiment, the relative position of each of the plurality of collet clearances 20b with respect to one spindle air supply channel 156 is the same for all the spindle air supply channels 156. Further, the number of the plurality of collet clearances 20b is the same as the number of the plurality of spindle air supply channels 156. The plurality of collet clearances 20b is disposed at equal intervals. The plurality of spindle air supply channels 156 is disposed at equal intervals. The phase positions of the plurality of spindle air supply channels 156 and the phase positions of the plurality of collet clearances 20b agree with each other. Therefore, the air discharged from each spindle air supply channel 156 passes through the housing space 10N and smoothly flows into the nearest collet clearance 20b. Thus, uneven flow of air can be reduced and disturbance of the straight flow can be reduced.

According to the first embodiment described above, the collet chuck 20 includes the plurality of collet clearances 20b each extending from the one collet end 20a toward the other end 10R of the main spindle 10. The spindle cylindrical portion 10H includes the plurality of air supply channels 120 for supplying air to the housing space 10N in the unclamped state. Therefore, the air supplied to the spindle air supply channels 156 temporarily remains in the housing space 10N, flows through the collet clearances 20b from the housing space 10N, and is discharged from the tapered hole 10T. Since the air passes through the collet clearances 20b and becomes the straight flow, it is possible to suppress the occurrence of the suction phenomenon near the central axis AX of the tapered hole 10T. The spindle device 1 includes the fourth air supply channel 155 serving as the annular channel that communicates the upstream sides of the plurality of spindle air supply channels 156. The fourth air supply channel 155 can achieve more uniform flow rates of air streams flowing into the plurality of spindle air supply channels 156. Therefore, it is possible to achieve more uniform flow rates of air streams that flow through the housing space 10N and become the straight flows through the plurality of collet clearances 20b. Since the air streams flowing out from the plurality of collet clearances 20b are less likely to be biased, it is possible to further suppress the occurrence of the suction phenomenon near the central axis AX of the tapered hole 10T. Since the defining surface that defines the housing space 10N includes the spindle cam surface 10M, air can be supplied to the housing space 10N including the spindle cam surface 10M. The plurality of collet clearances 20b is clearances between the collet claws 21 among the plurality of collet claws 21. This allows air to flow into the clearances between the collet claws 21.

The relative position of each of the plurality of collet clearances 20b with respect to each spindle air supply channel 156 is the same among the plurality of spindle air supply channels 156. Therefore, the path from the spindle air supply channel 156 to the collet clearance 20b is substantially equal among all the spindle air supply channels 156. Thus, the air streams discharged from the spindle air supply channels 156 are less likely to be biased, and the air easily flows straight through the tapered hole 10T. Accordingly, it is possible to further suppress the occurrence of the suction phenomenon.

The number of the plurality of collet clearances 20b is the same as the number of the plurality of spindle air supply channels 156. The plurality of collet clearances 20b is disposed at equal intervals. The plurality of spindle air supply channels 156 is disposed at equal intervals. Therefore, the air discharged from the spindle air supply channel 156 is guided to the nearby collet clearance 20b for all the spindle air supply channels 156. Thus, the air streams are less likely to be biased and the air flows straight. Accordingly, it is possible to suppress the occurrence of the suction phenomenon. The phase positions of the plurality of spindle air supply channels 156 and the phase positions of the plurality of collet clearances 20b agree with each other. Therefore, the air discharged from each spindle air supply channel 156 smoothly flows into the nearest collet clearance 20b. Thus, disturbance of the flow of air is unlikely to occur. Accordingly, the air flows straight and the occurrence of the suction phenomenon can be suppressed.

The spindle device 1 includes the disc springs 33 that bias the draw bar 30, and the cylinder device 15 that presses the disc springs 33. Therefore, the present application can be applied to the spindle device 1 including the disc springs 33 and the cylinder device 15. The spindle device 1 includes the inner pipe 36, the downstream channel 35B disposed outside the inner pipe 36, the third coolant channel 38 disposed inside the inner pipe 36, the sixth air supply channel 126, and the fourth air supply channel 155. Therefore, the present application can be applied to the spindle device 1 including the inner pipe 36, the downstream channel 35B, the sixth air supply channel 126, the fourth air supply channel 155, and the third coolant channel 38.

### B. Other Embodiments of First Embodiment

(B1) In the first embodiment, the phase positions of the plurality of air supply channels 120 and the phase positions of the plurality of collet clearances 20b agree with each other. Apart from this configuration, a configuration may also be adopted in which the phase positions of the plurality of spindle air supply channels 156 and the phase positions of the plurality of collet clearances 20b do not agree with each other. Even in the case where the phase positions of the plurality of spindle air supply channels 156 and the phase positions of the plurality of collet clearances 20b deviate from each other, the air streams discharged from the plurality of spindle air supply channels 156 flow into the nearby collet clearances 20b along similar paths. Therefore, the air streams are less likely to be biased. Accordingly, the air can become the straight flow and the occurrence of the suction phenomenon can be reduced.
(B2) In the first embodiment, the number of the plurality of collet clearances 20b is the same as the number of the plurality of spindle air supply channels 156. The plurality of collet clearances 20b is disposed at equal intervals. The plurality of spindle air supply channels 156 is disposed at equal intervals. Apart from this configuration, for example, a configuration may also be adopted in which the number of the collet clearances 20b is larger than the number of the spindle air supply channels 156. In the case of this configuration, it is appropriate that the relative position of each of the collet clearances 20b with respect to the spindle air supply channel 156 be the same for all the spindle air supply channels 156. Therefore, the air streams can be less likely to be biased.
(B3) In the first embodiment, the plurality of spindle air supply channels 156 is provided, but one spindle air supply channel 156 may be provided. Even in this case, the air supplied from the spindle air supply channel 156 to the housing space 10N flows in the circumferential direction by the housing space 10N. Therefore, the air is supplied to the plurality of collet clearances 20b.

### C. Second Embodiment

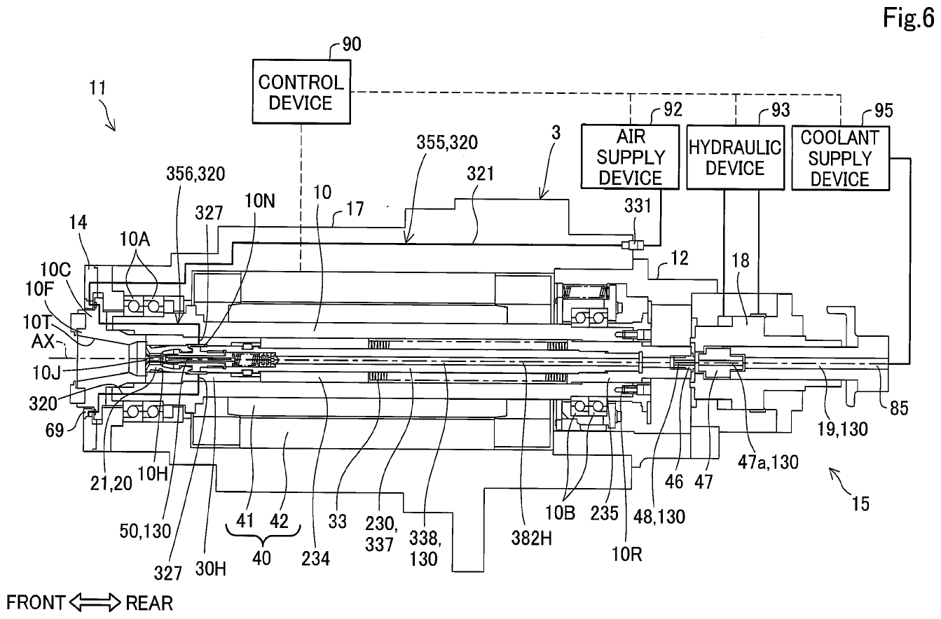

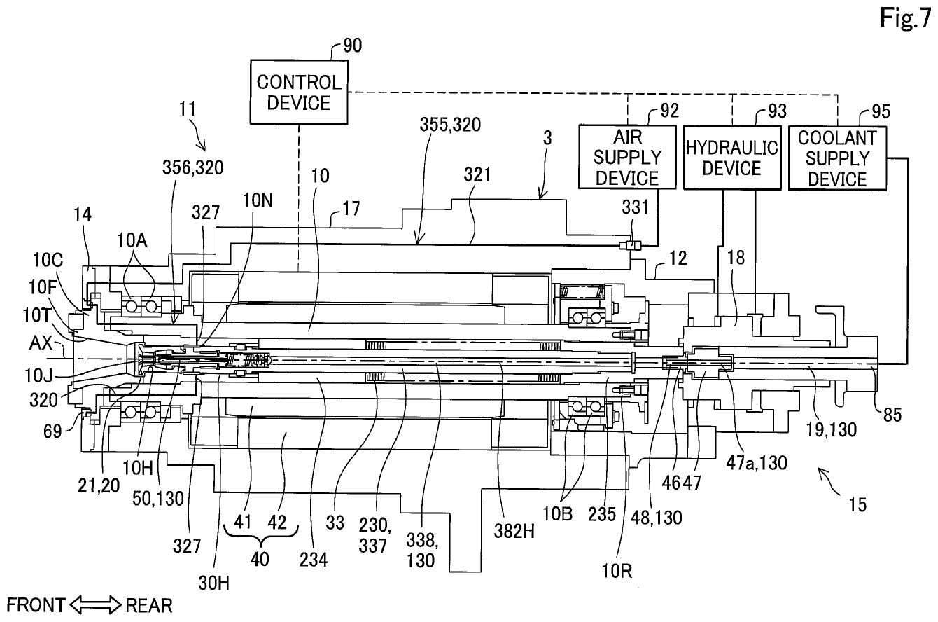

FIG. 6 is a first schematic diagram showing a sectional view of a spindle device 11 of a second embodiment. FIG. 7 is a second schematic diagram showing the sectional view of the spindle device 11 of the second embodiment. FIG. 6 is a diagram of the clamped state, and FIG. 7 is a diagram of the unclamped state. The main difference between the spindle device 11 and the spindle device 1 of the first embodiment is that an air supply channel 320 is formed on the outer side in the radial direction with respect to an axial hole 10J of the main spindle 10. The air supply channel 320 includes an upstream air supply channel 355 (FIG. 6) formed in a non-rotary element of the spindle device 11, and a downstream air supply channel 356 (FIG. 6) positioned downstream of the upstream air supply channel 355 and formed in a rotary element of the spindle device 11. Details of the upstream air supply channel 355 and the downstream air supply channel 356 will be described later. In the spindle device 11, the same components as those in the first embodiment are represented by the same reference numerals and the description thereof will be omitted as appropriate.

The spindle device 11 includes the cylindrical spindle housing 3, the main spindle 10, the front bearing 10A, the rear bearing 10B, the electric motor 40, a draw bar 230, the collet chuck 20, the disc spring 33 serving as the biasing member, the cylinder device 15, and the control device 90.

In the spindle housing 3, the main elements of the spindle device 1 such as the main spindle 10 and the electric motor 40 are disposed inside. The spindle housing 3 includes a housing body 17 that houses the electric motor 40, a bearing housing 12 fixed to the other end of the housing body 17, and a cylindrical front cap 14 constituting one housing end that is the front end (one end) of the spindle housing 3. The front cap 14 is fixed to the housing body 17 together with a first front outer ring retainer 61 described later with bolts.

The main spindle 10 has the axial hole 10J extending in the axial direction and including the tapered hole 10T and the spindle cylindrical portion 10H as elements. The front bearing 10A and the rear bearing 10B support the main spindle 10 so that it is rotatable relative to the spindle housing 3. The collet chuck 20 is disposed inside the spindle cylindrical portion 10H and is configured to grip a tool. In the present embodiment, the front bearing 10A and the rear bearing 10B are angular rolling bearings. The front bearing 10A is positioned on the front side with respect to the electric motor 40 and is disposed at a position near the one end 10F in the axial direction. The rear bearing 10B is positioned on the rear side with respect to the electric motor 40 and is disposed at a position near the other end 10R in the axial direction.

The drawbar 230 is connected to the other collet end of the collet chuck 20 and moves the collet chuck 20 forward and backward along the axial direction. The draw bar 230 is different from the draw bar 30 in that, unlike the first embodiment, the draw bar 230 is not divided into an inner pipe and an outer pipe but is a single pipe. The draw bar 230 has a rod hole 382H extending through it in the axial direction. The rod hole 382H communicates with the fourth coolant channel 47a of the fixed joint 47. The rod hole 382H forms a rod coolant channel 338 through which the coolant supplied from the fourth coolant channel 47a flows. The coolant that has flowed through the rod coolant channel 338 is supplied to the machining point that is the cutting edge of the tool positioned on the one end 10F side via the inside of the tool. Similarly to the first embodiment, the draw bar 230 includes a draw bolt on one end side, and a cylindrical spool disposed inside the draw bolt. The inside of this cylindrical spool constitutes the downstream side of the rod coolant channel 338.

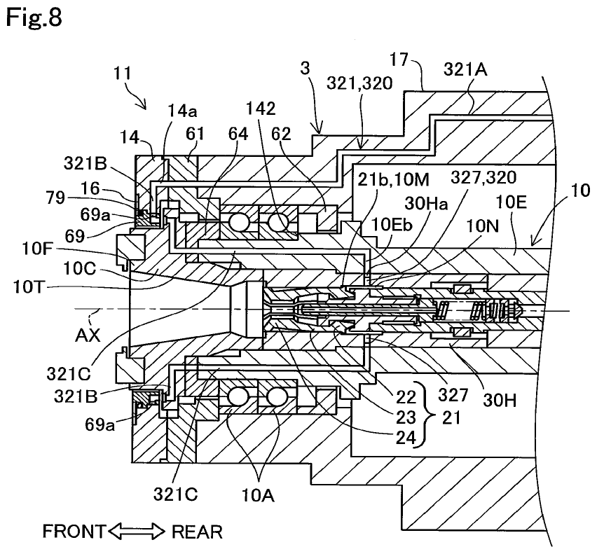

In the second embodiment, the collet chuck 20 has the same configuration as that of the collet chuck 20 (FIG. 3) of the first embodiment though the illustration is simplified. Similarly to the first embodiment, the spindle cylindrical portion 10H has the housing space 10N in which the other collet end 20c (FIG. 3) is housed in the clamped state. Similarly to the first embodiment, the defining surface that defines the housing space 10N includes the spindle cam surface 10M (FIG. 8) that comes into contact with the first claw cam surfaces 21b (FIG. 8) serving as the collet cam surface when the collet chuck 20 moves forward.

The spindle device 11 further includes a front member 234 and a rear member 235 that are disposed on the outer circumferential side of a push rod 337 of the draw bar 230. The front member 234 and the rear member 235 each have a cylindrical shape. The front member 234 and the rear member 235 are disposed away from each other in the axial direction. The disc springs 33 are disposed in a compressed state between the front member 234 and the rear member 235. The front end of the disc springs 33 is in contact with the front member 234, and the rear end of the disc springs 33 is in contact with the rear member 235. The rear member 235 is fixed to the outer circumferential surface of the push rod 337. Therefore, the rear member 235 operates in conjunction with the push rod 337. The front member 234 is disposed in the axial hole 10J of the main spindle 10. The rear member 235 is pushed forward by the piston 18 of the cylinder device 15 when the piston 18 moves forward. Therefore, the push rod 337 moves forward in conjunction with the rear member 235, and the collet chuck 20 also moves forward. As shown in FIG. 7, the collet claws 21 are opened in the axial hole 10J when the collet chuck 20 moves forward. Thus, the spindle device 11 comes into the unclamped state. The piston 18 moves forward and rearward by supplying hydraulic oil to a cylinder chamber and discharging the hydraulic oil from the cylinder chamber by a hydraulic device 93 of the spindle device 11. Although the hydraulic device 93 is also provided in the spindle device 1 of the first embodiment, illustration thereof is omitted in the first embodiment.

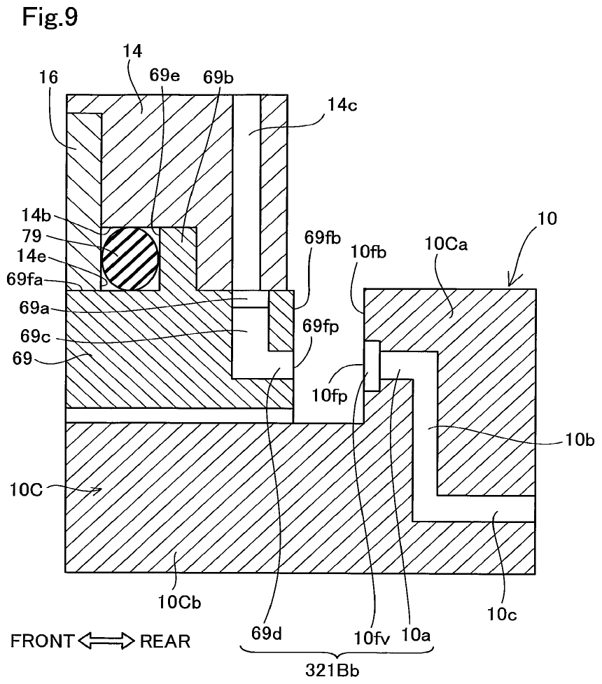

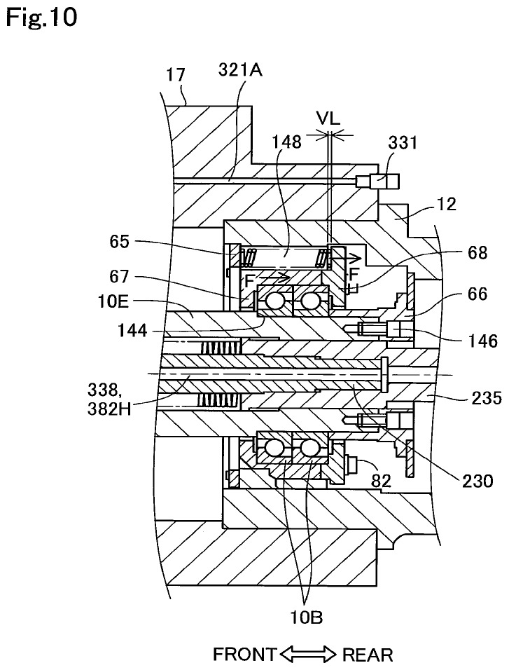

FIG. 8 is a diagram showing a front part of the spindle device 11. FIG. 9 is a schematic diagram showing part of the spindle device 11. FIG. 10 is a diagram showing a rear part of the spindle device 11. FIGS. 8 and 9 are diagrams of a case where the spindle device 11 is in the clamped state. The configuration of the spindle device 11 will further be described with reference to FIGS. 8 to 10.

As shown in FIG. 8, the spindle device 11 further includes the first front outer ring retainer 61, a second front outer ring retainer 62, and a front inner ring retainer 64. The first front outer ring retainer 61 and the second front outer ring retainer 62 restrict movement of an outer ring of the front bearing 10A in the axial direction by holding the outer ring of the front bearing 10A in the axial direction. The second front outer ring retainer 62 is disposed on the inner circumferential surface of the housing body 17. The first front outer ring retainer 61 is held between the housing body 17 and the front cap 14 and its position is fixed. The front inner ring retainer 64 and a stepped surface 142 formed on the outer circumferential surface of a spindle body 10E of the main spindle 10 restrict movement of an inner ring of the front bearing 10A in the axial direction by holding the inner ring of the front bearing 10A. The front inner ring retainer 64 is held between the spindle body 10E and the spindle cap 10C that constitutes the main spindle 10.

The spindle device 11 further includes a sleeve 69, a retaining plate 16, and a sealer 79. The sleeve 69 has a cylindrical shape and is positioned between the front cap 14 and the spindle cap 10C in the radial direction. The sleeve 69 surrounds the spindle cap 10C about the axial direction. The sleeve 69 is disposed on the inner circumferential surface of the front cap 14 so as to be movable in the axial direction. As shown in FIG. 9, a protrusion 69b that protrudes in the radially outward direction from an outer circumferential surface 69fa is formed on the outer circumference of the sleeve 69. The protrusion 69b is formed on the outer circumferential surface 69fa of the sleeve 69 in the circumferential direction. The rear end face of the protrusion 69b is in contact with a stepped portion of the front cap 14. A third end face 69e that is the front end face of the protrusion 69b is in contact with the sealer 79 described later. Since the third end face 69e is also the component of the protrusion 69b, it protrudes in the radially outward direction from the outer circumferential surface 69fa. The retaining plate 16 has a disc shape and is attached to the front cap 14 with bolts. A fourth end face 14e that is the rear end face of the retaining plate 16 is in contact with the sealer 79. The third end face 69e and the fourth end face 14e face each other in the axial direction and hold the sealer 79 therebetween. The sealer 79 is positioned so as to enter a recess 14b defined by the front cap 14 and the retaining plate 16. The sleeve 69 further has a first end face 69fb that is an end face on the other end (rear) side in the axial direction. The sleeve 69 is pushed toward the front cap 14 by the retaining plate 16 and the sealer 79, but rotates about the central axis AX to some extent due to a frictional force along with rotation of the main spindle 10. The sleeve 69 can also be said to be the component of the spindle housing 3.

As shown in FIG. 9, the sealer 79 is an annular elastic member disposed so as to surround the outer circumferential surface 69fa of the sleeve 69. For example, synthetic rubber is used as the sealer 79. The sealer 79 is disposed between the third end face 69e and the fourth end face 14e while being compressed in the axial direction. The sealer 79 suppresses leakage of air flowing through the air supply channel 320 to the outside.

The spindle cap 10C forming the tapered hole 10T (FIG. 8) includes a cap small diameter portion 10Cb positioned on the radially inner side of the spindle housing 3, and a cap large diameter portion 10Ca having a larger outside diameter than the cap small diameter portion 10Cb. The cap large diameter portion 10Ca is positioned on the other end side (rear side) with respect to the cap small diameter portion 10Vb in the axial direction. The cap large diameter portion 10Ca protrudes radially outward with respect to the second minimum inner circumference of the first front outer ring retainer 61 and the inner circumference of the sleeve 69. The cap large diameter portion 10Ca has a second end face 10fb that faces the first end face 69fb of the sleeve 69 in the axial direction. In the clamped state, the first end face 69fb and the second end face 10fb are separated from each other in the axial direction.

As shown in FIG. 10, the spindle device 11 further includes a first rear outer ring retainer 67, a second rear outer ring retainer 68, a rear inner ring retainer 66, a closing plate 65, and a preload spring 148. The closing plate 65 has a disc shape and is fixed to the inner circumferential surface of the bearing housing 12. The bearing housing 12 is fixed to the other end of the housing body 17. The bearing housing 12 is the component of the spindle housing 3. The first rear outer ring retainer 67 and the second rear outer ring retainer 68 are fixed to each other with bolts 82. The first rear outer ring retainer 67 and the second rear outer ring retainer 68 restrict movement of an outer ring of the rear bearing 10B in the axial direction. The rear inner ring retainer 66 is fastened to the spindle body 10E with bolts 146. The second rear outer ring retainer 68 and a stepped surface 144 formed on the outer circumferential surface of the spindle body 10E restrict movement of an inner ring of the front bearing 10A in the axial direction by holding the inner ring of the rear bearing 10B. The preload spring 148 applies a preload to the rear bearing 10B and the front bearing 10A. A plurality of preload springs 148 is disposed at regular intervals in the circumferential direction about the axial direction. One end of the preload springs 148 is in contact with the closing plate 65, and the other end of the preload springs 148 is in contact with the second rear outer ring retainer 68. Therefore, the second rear outer ring retainer 68 receives a rearward external force F from the preload springs 148 and is displaced rearward by a value VL in the clamped state compared to the unclamped state. The first rear outer ring retainer 67 integrated with the second rear outer ring retainer 68 with the bolts 82 is also displaced rearward by the value VL. Therefore, the outer ring of the rear bearing 10B is pushed rearward. In this way, the preload is applied to the rear bearing 10B and the front bearing 10A. The value VL is 0.2 mm in the present embodiment. When the state of the spindle device 11 makes transition from the clamped state to the unclamped state, the rear member 235 and the draw bar 230 are pushed forward by the piston 18. In this case, the main spindle 10 is slightly displaced forward by receiving a forward thrust of the piston 18 against the pushing force of the disc springs 33. In the present embodiment, the main spindle 10 is displaced forward by 0.2 mm in the unclamped state compared to the clamped state.

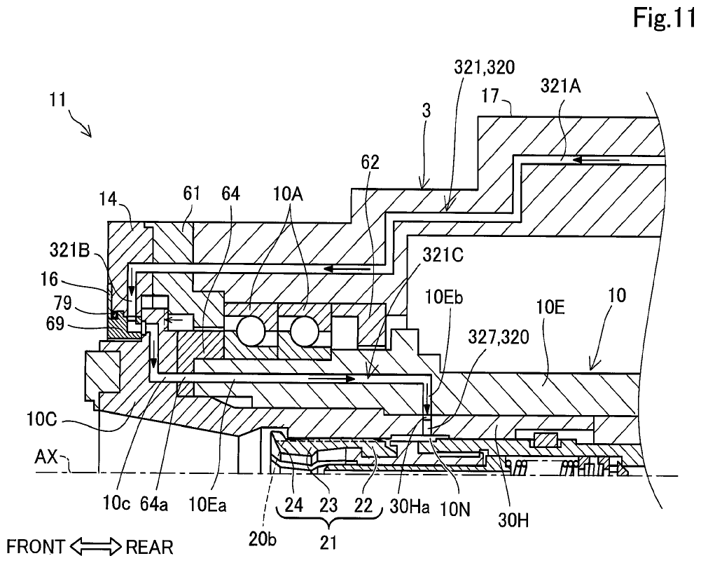

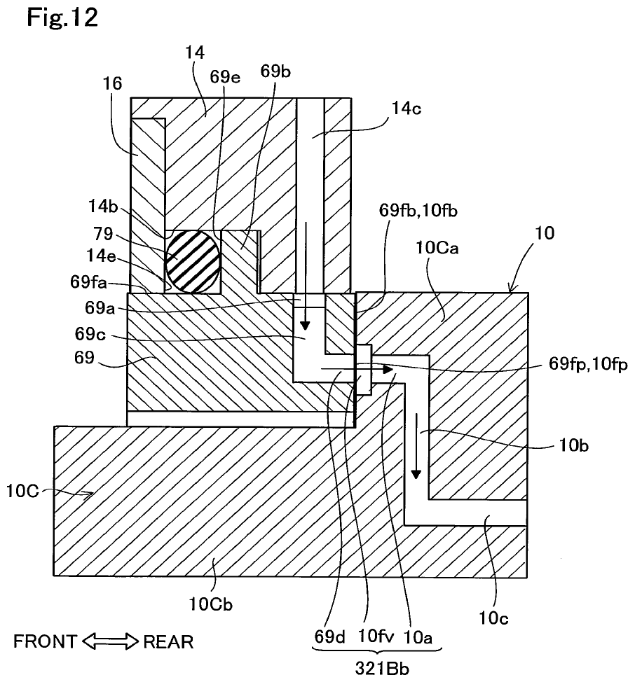

Next, details of the air supply channel 320 will be described with reference to FIGS. 11 and 12 in addition to FIGS. 7 to 10. FIG. 11 is a diagram of the case where the spindle device 11 is in the unclamped state. FIG. 12 is a schematic diagram of part of the spindle device 11 shown in FIG. 11. Regarding the air supply channel 320, the upstream side and the downstream side are based on the air flow direction. As shown in FIG. 7, an upstream end 331 of the air supply channel 320 is formed at the rear end of the spindle housing 3 (specifically, the housing body 17). The air supply device 92 communicates with the upstream end 331 via a flow pipe. The air supply device 92 sends pressurized air into the air supply channel 320 via the upstream end 331 when the spindle device 11 is in the unclamped state.

The air supply channel 320 includes, in order from the upstream side to the downstream side, an air communication channel 321 (FIGS. 7, 8, 10) including the upstream end 331, an annular channel 30Ha (FIGS. 8, 11), and spindle air supply channels 327 (FIG. 8) connected to the downstream end of the air communication channel 321 via the annular channel 30Ha. As shown in FIG. 8, the downstream ends of the spindle air supply channels 327 are open to the housing space 10N. Air that has flowed into the housing space 10N from the spindle air supply channels 327 temporarily remains in the housing space 10N, and then flows from the housing space 10N toward the tapered hole 10T via the collet clearances 20b. In the present embodiment, the number of the spindle air supply channels 327 is six that is the same as in the first embodiment described above. The air supplied from the spindle air supply channels 327 to the housing space 10N flows through the housing space 10N formed in the circumferential direction. Therefore, the air flows into the six collet clearances 20b (FIG. 3).

As shown in FIG. 7, the air communication channel 321 is formed on the outer side in the radial direction with respect to the spindle air supply channels 327. As shown in FIGS. 8 and 9, the air communication channel 321 includes, in order from the upstream side to the downstream side, an upstream communication channel 321A formed in a non-rotary element, and a downstream communication channel 321C formed in a rotary element. In this way, the upstream communication channel 321A is a channel formed in the non-rotary element of the spindle device 11, and the downstream communication channel 321C is a channel formed in the rotary element of the spindle device 11. In the present embodiment, the upstream communication channel 321A is formed in the housing body 17, the first front outer ring retainer 61, and the front cap 14 that are non-rotary elements. The upstream communication channel 321A allows air flowing from the upstream end 331 (FIG. 10) to flow to the inside of the front cap 14 positioned on the front side with respect to the front bearing 10A. The downstream communication channel 321C is formed in the sleeve 69, the spindle cap 10C, the front inner ring retainer 64, and the spindle body 10E that are rotary elements. In the upstream communication channel 321A and the downstream communication channel 321C, a channel positioned on the one end 10F side with respect to the front bearing 10A in the axial direction is a one-end channel 321B. In the present embodiment, the one-end channel 321B is formed in the first front outer ring retainer 61, the front cap 14 that is part of the spindle housing 3, the sleeve 69, the spindle cap 10C that is part of the main spindle 10, and the front inner ring retainer 64. That is, the one-end channel 321B is formed in the downstream portion of the upstream communication channel 321A and the upstream portion of the downstream communication channel 321C.

As shown in FIG. 8, the air supply channel 320 branches into two channels from a connecting channel 69a (FIGS. 8 and 9) that is an annular groove formed on the outer circumferential surface of the sleeve 69 to the annular channel 30Ha described later. These two branched channels are formed at positions where they face each other in the radial direction. The number of the branched channels in the air supply channel 320 from the connecting channel 69a (FIGS. 8 and 9) to the annular channel 30Ha described later is not limited to two as described above, and may be, for example, three.

The front cap 14 includes, in order from the upstream side to the downstream side, an axial channel 14a shown in FIG. 8 and a radial channel 14c shown in FIG. 9 connected to the axial channel 14a. The axial channel 14a and the radial channel 14c constitute the one-end channel 321B. The axial channel 14a is a channel extending along the axial direction. The radial channel 14c is a channel that is connected to the downstream end of the axial channel 14a and extends in the radial direction.

As shown in FIG. 9, the sleeve 69 includes, in order from the upstream side to the downstream side, the connecting channel 69a that is the annular groove formed on the outer circumferential surface 69fa, a radial channel 69c, and an axial channel 69d. The connecting channel 69a, the radial channel 69c, and the axial channel 69d constitute the one-end channel 321B. The connecting channel 69a is formed at a position where it faces the radial channel 14c in the radial direction of the main spindle 10. The radial channel 69c is a channel extending along the radial direction. The upstream end of the radial channel 69c is connected to the connecting channel 69a. The axial channel 69d is a channel extending along the axial direction. The upstream end of the axial channel 69d is connected to the radial channel 69c. The downstream end of the axial channel 69d is a first opening 69fp formed in the first end face 69fb.

As shown in FIG. 9, the spindle cap 10C includes, in order from the upstream side to the downstream side, a circumferential groove 10fv, a first axial channel 10a, a radial channel 10b, and a second axial channel 10c. The circumferential groove 10fv, the first axial channel 10a, the radial channel 10b, and the second axial channel 10c constitute the one-end channel 321B. The circumferential groove 10fv is a groove channel formed in the second end face 10fb in the circumferential direction. A portion of the circumferential groove 10fv on the second end face 10fb side is a second opening 10fp. The first axial channel 10a is a channel extending along the axial direction. The upstream end of the first axial channel 10a is connected to the circumferential groove 10fv. The radial channel 10b is a channel extending along the radial direction. The upstream end of the radial channel 10b is connected to the first axial channel 10a. The second axial channel 10c is a channel extending along the axial direction. The upstream end of the second axial channel 10c is connected to the downstream end of the radial channel 10b.

The axial channel 69d, the circumferential groove 10fv, and the first axial channel 10a constitute an axial channel 321 Bb that extends in the axial direction and includes the first opening 69fp and the second opening 10fp. As shown in FIG. 9, in the clamped state, the axial channel 69d and the circumferential groove 10fv face each other with a slight clearance in the axial direction.

When the state of the spindle device 11 makes transition from the clamped state to the unclamped state as shown in FIG. 12, the cylinder device 15 moves the main spindle 10 including the spindle cap 10C forward to move the second end face 10fb closer to the first end face 69fb. Therefore, in the unclamped state, the first end face 69fb and the second end face 10fb come into contact with each other. In the unclamped state, the rotational phase position of the main spindle 10 is controlled and stopped so that the axial channel 69d and the first axial channel 10a are aligned in the axial direction. By controlling and stopping the rotational phase position of the main spindle 10, bringing the state into the unclamped state, supplying air, and aligning the axial channel 69d and the first axial channel 10a in the axial direction, the air smoothly flows from the upstream side to the downstream side of the axial channel 321Bb. When the second end face 10fb moves forward and comes into contact with the first end face 69fb, the first end face 69fb is also slightly displaced forward. Since the sealer 79 is compressed in the axial direction at least in the unclamped state, it biases the sleeve 69 toward the second end face 10fb. Therefore, the first end face 69fb of the sleeve 69 and the second end face 10fb come into close contact with each other in the unclamped state. Thus, it is possible to suppress leakage of air to the outside from the axial channel 321Bb. Since the first end face 69fb and the second end face 10fb are in close contact with each other by the elastic force of the sealer 79, the amount of wear on the first end face 69fb and the second end face 10fb can be reduced.

As shown in FIG. 11, the front inner ring retainer 64 includes an axial channel 64a extending along the axial direction. The upstream end of the axial channel 64a is connected to the second axial channel 10c formed in the spindle cap 10C. The spindle body 10E includes, in order from the upstream side to the downstream side, an axial channel 10Ea extending along the axial direction and a radial channel 10Eb extending along the radial direction. The upstream end of the axial channel 10Ea is connected to the axial channel 64a. The upstream end of the radial channel 10Eb is connected to the axial channel 10Ea. The axial channel 64a, the axial channel 10Ea, and the radial channel 10Eb constitute the downstream communication channel 321C.

As shown in FIG. 8, the downstream end of the radial channel 10Eb that is the downstream end of the downstream communication channel 321C is connected to the annular channel 30Ha. The annular channel 30Ha is an annular groove formed about the central axis AX on the outer circumferential surface of the collet sleeve 30H. As shown in FIGS. 8 and 11, the upstream sides of the plurality of spindle air supply channels 327 are connected to the annular channel 30Ha. That is, the annular channel 30Ha communicates the plurality of spindle air supply channels 327 with each other. Air steams flowing through the radial channels 10Eb of two downstream communication channels 321C flow uniformly into the six spindle air supply channels 327 via the annular channel 30Ha. The air streams that have flowed into the spindle air supply channels 327 flow into the housing space 10N. The air that has flowed into the housing space 10N becomes a straight flow by flowing through the collet clearance 20b.

According to the second embodiment, the same effects as those of the first embodiment can be achieved in that the second embodiment has the same configuration as that of the first embodiment. For example, the air supplied to the housing space 10N becomes the straight flow through the collet clearance 20b. Therefore, even if the tool is removed from the tapered hole 10T, the occurrence of the suction phenomenon can be suppressed near the central axis AX of the tapered hole 10T. As shown in FIG. 8, the spindle device 11 includes the annular channel 30Ha that communicates the upstream sides of the plurality of spindle air supply channels 327. The annular channel 30Ha can achieve more uniform flow rates of air streams flowing into the plurality of spindle air supply channels 156. Therefore, it is possible to achieve more uniform flow rates of air streams that flow through the housing space 10N and become the straight flows through the plurality of collet clearances 20b. Since the air streams flowing out from the plurality of collet clearances 20b are less likely to be biased, it is possible to further suppress the occurrence of the suction phenomenon near the central axis AX of the tapered hole 10T. According to the second embodiment, the air communication channel 321 including the one-end channel 321B is formed on the outer side in the radial direction with respect to the spindle air supply channels 327. Therefore, complication of the configuration of the spindle device 1 can be suppressed compared to a case where the air communication channel 321 is formed on the inner side in the radial direction with respect to the spindle air supply channels 327 in the main spindle 10, for example, in the axial hole 10J of the main spindle 10. Since there is no need to form the air communication channel 321 inside, for example, the draw bar 230, the draw bar 230 need not have a double pipe structure. Since the front cap 14 and the spindle cap 10C can be assembled easily by forming part of the air communication channel 321 in the front cap 14 and the spindle cap 10C, the one-end channel 321B can be formed easily. By forming the one-end channel 321B in the spindle housing 3 and the main spindle 10, there is no need to newly use another member for forming the one-end channel 321B. According to the second embodiment, as shown in FIG. 12, the axial channel 321Bb spanning the spindle housing 3 and the main spindle 10 can be formed by bringing the first end face 69fb and the second end face 10fb into contact with each other at a position where the first opening 69fp of the spindle housing 3 that is the non-rotary element and the second opening 10fp of the main spindle 10 that is the rotary element face each other.

### D. Other Embodiment of Second Embodiment

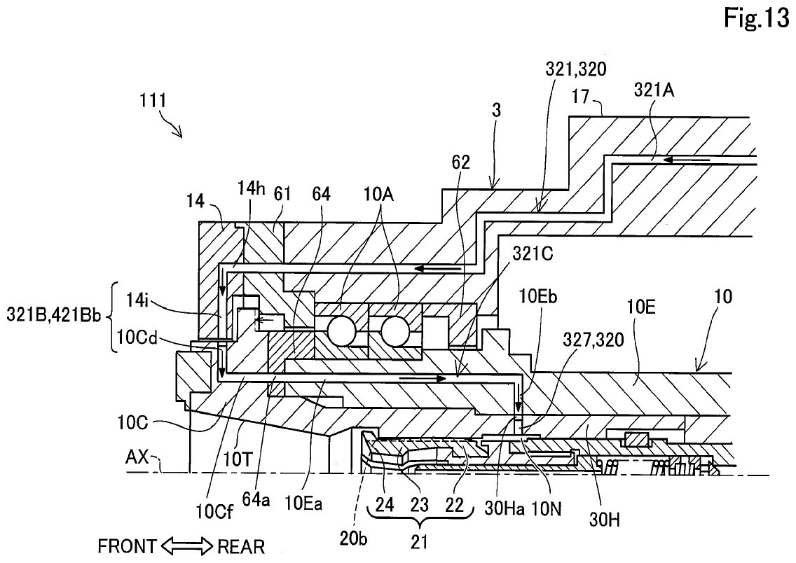

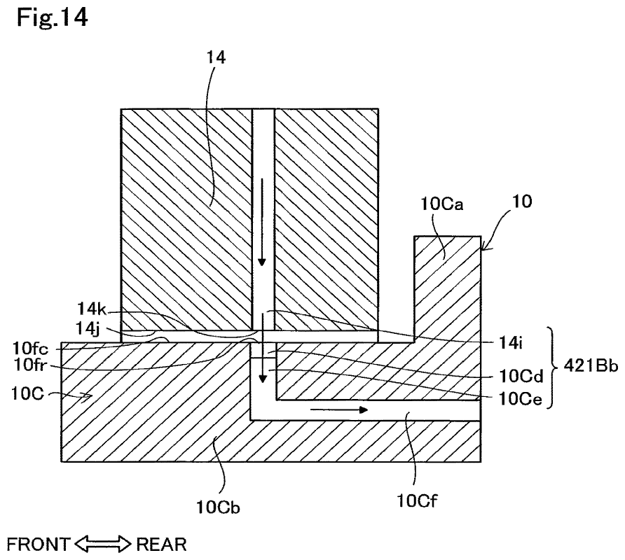

FIG. 13 is a first diagram illustrating another embodiment of the second embodiment. FIG. 14 is a second diagram illustrating the other embodiment of the second embodiment. FIG. 13 is a diagram corresponding to FIG. 11, and is a diagram showing the unclamped state. FIG. 14 is a diagram corresponding to FIG. 12, and shows the one-end channel 321B in the unclamped state. In the first embodiment, as shown in FIG. 12, the one-end channel 321B includes the axial channel 321Bb constituted by the axial channel 69d, the circumferential groove 10fv, and the first axial channel 10a. Instead of this, the one-end channel 321B may include, for example, a radial channel 421Bb extending in the radial direction as shown in FIG. 13. Unlike the spindle device 11 of the second embodiment shown in FIG. 11, a spindle device 111 shown in FIG. 13 does not include the sleeve 69, the sealer 79, and the retaining plate 16. In the present embodiment, the one-end channel 321B is formed in the first front outer ring retainer 61, the front cap 14 that is part of the spindle housing 3, the spindle cap 10C that is part of the main spindle 10, and the front inner ring retainer 64. Two downstream communication channels 321C are formed in the spindle cap 10C, the front inner ring retainer 64, and the spindle body 10E that are the rotary elements shown in FIG. 13 by branching at an annular groove 10Cd, but the number is not limited to this and three channels may be formed. When the number of the downstream communication channels 321C is two, for example, the downstream communication channels 321C are provided at positions where they face each other in the radial direction of the main spindle 10.

The front cap 14 of the spindle housing 3 includes, in order from the upstream side to the downstream side, an axial channel 14h extending along the axial direction shown in FIG. 13, and a radial channel 14i extending along the radial direction shown in FIG. 14. The downstream end of the axial channel 14h is connected to the upstream end of the radial channel 14i. The axial channel 14h and the radial channel 14i constitute the one-end channel 321B. The downstream end of the radial channel 14i has an inner circumferential surface opening 14k that is open to an inner circumferential surface 14j of the front cap 14. The inner circumferential surface 14j is positioned on the front side (one end side) with respect to the front bearing 10A. The inner circumferential surface 14j described above is also referred to as a one-end housing inner circumferential surface 14j.

The spindle cap 10C of the main spindle 10 includes, in order from the upstream side to the downstream side, the annular groove 10Cd, a radial channel 10Ce extending along the radial direction, and an axial channel 10Cf extending along the axial direction. The annular groove 10Cd, the radial channel 10Ce, and the axial channel 10Cf constitute the one-end channel 321B. The annular groove 10Cd is a groove channel formed in an outer circumferential surface 10fc of the cap small diameter portion 10Cb in the circumferential direction. The outer circumferential surface 10fc is also referred to as a one-end spindle outer circumferential surface 10fc. The annular groove 10Cd has an outer circumferential surface opening 10fr that is open radially outward. The upstream end of the radial channel 10Ce is connected to the annular groove 10Cd. The downstream end of the radial channel 10Ce is connected to the axial channel 10Cf. The control device 90 controls and stops the rotational phase position of the main spindle 10 so that the radial channel 10Ce is disposed at a position where it faces the inner circumferential surface opening 14k in the radial direction in the unclamped state, or so that two radial channels 10Ce are disposed at positions of 90 degrees and 270 degrees when the inner circumferential surface opening 14k is at a position of 0 degrees. Then, the state is brought into the unclamped state and air is supplied. The air supply is stopped when the state is changed from the unclamped state to the clamped state. The radial channel 14i, the annular groove 10Cd, and the radial channel 10Ce constitute the radial channel 421 Bb extending in the radial direction in the unclamped state. In the present embodiment, even when the main spindle 10 is slightly displaced forward in transition from the clamped state to the unclamped state, the cap large diameter portion 10Ca and the front cap 14 are positioned away from each other in the axial direction.

Air that has flowed through the radial channel 421Bb shown in FIG. 14 sequentially flows through the axial channel 10Cf, the axial channel 64a of the front inner ring retainer 64 shown in FIG. 13, and the axial channel 10Ea and the radial channel 10Eb of the spindle body 10E, and flows into the spindle air supply channels 327 via the annular channel 30Ha. As shown in FIG. 14, the boundary between the radial channel 14i and the annular groove 10Cd in the radial channel 421Bb is formed by a clearance between the inner circumferential surface 14j and the outer circumferential surface 10fc. This clearance is part of an annular clearance about the central axis AX. Clearances (both-side clearances) between the inner circumferential surface 14j and the outer circumferential surface 10fc are also formed on both sides of the boundary of the radial channel 421Bb in the axial direction. The both-side clearances have a channel resistance that can suppress leakage of air flowing through the radial channel 421Bb to the outside. With the channel resistance of the both-side clearances, the leakage of air from the radial channel 421Bb can be suppressed.

According to the other embodiment described above, the channel spanning the spindle housing 3 that is the non-rotary element and the main spindle 10 that is the rotary element can be formed as the radial channel 421Bb. The spindle device 11 may include both the axial channel 321Bb shown in FIG. 12 and the radial channel 421Bb shown in FIG. 14.

The present disclosure is not limited to the embodiments described above, and can be implemented with a variety of configurations without departing from the spirit thereof. For example, the technical features of the embodiments corresponding to the technical features in the aspects described in the SUMMARY OF THE INVENTION can be replaced or combined as appropriate in order to solve part or all of the problems described above or achieve part or all of the effects described above. The technical features can be omitted as appropriate unless such technical features are described as being essential in the present specification.

### DESCRIPTION OF THE REFERENCE NUMERALS

1, 11 . . . spindle device, 3 . . . spindle housing, 10 . . . main spindle, 10a . . . first axial channel, 10b . . . radial channel, 10c . . . second axial channel, 10A . . . front bearing, 10B . . . rear bearing, 10C . . . spindle cap, 10Ca . . . cap large diameter portion, 10Cb . . . cap small diameter portion, 10Cd . . . annular groove, 10Ce . . . radial channel, 10Cf . . . axial channel, 10D . . . stepped portion, 10E . . . spindle body, 10Ea . . . axial channel, 10Eb . . . radial channel, 10F . . . one end, 10H . . . spindle cylindrical portion, 10J . . . axial hole, 10M . . . spindle cam surface, 10N . . . housing space, 10P . . . spindle protrusion, 10R . . . other end, 10T . . . tapered hole, 10fb . . . second end face, 10fc . . . outer circumferential surface, 10fp . . . second opening, 10fr . . . outer circumferential surface opening, 10fv . . . circumferential groove, 10fv . . . circumferential groove, 12 . . . bearing housing, 14 . . . front cap, 14a, 14h . . . axial channel, 14b . . . recess, 14c, 14i . . . radial channel, 14e . . . fourth end face, 14j . . . inner circumferential surface, 14k . . . inner circumferential surface opening, 15 . . . cylinder device, 16 . . . retaining plate, 17 . . . housing body, 18 . . . piston, 19 . . . first coolant channel, 20 . . . collet chuck, 20a . . . one collet end, 20b . . . collet clearance, 20c . . . other collet end, 21 . . . collet claw, 21a . . . claw slope, 21b . . . first claw cam surface, 21c . . . collet recess, 21d . . . second claw cam surface, 22 . . . collet base, 23 . . . collet cylindrical portion, 24 . . . collet tip, 25 . . . spool, 24b . . . inner circumferential protrusion, 26 . . . draw bolt, 26a . . . bolt slope, 27 . . . one draw bolt end, 28 . . . other draw bolt end, 30 . . . drawbar, 30A . . . outer circumferential drawbar, 30D, 30I . . . large diameter portion, 30F . . . one drawbar end, 30G . . . guide sleeve, 30H . . . collet sleeve, 30Ha . . . annular channel, 30R . . . other drawbar end, 31H . . . first rod hole, 32H . . . second rod hole, 33 . . . disc spring, 34 . . . collar, 35 . . . second air supply channel, 35A . . . upstream channel, 35B . . . downstream channel, 35C . . . other-end air channel, 35D . . . one-end air channel, 36 . . . inner pipe, 36A . . . one pipe end, 36B . . . other pipe end, 37 . . . push rod, 38 . . . third coolant channel, 40 . . . electric motor, 41 . . . rotor, 42 . . . stator, 46 . . . rotary joint, 47 . . . fixed joint, 47a . . . fourth coolant channel, 48 . . . second coolant channel, 49 . . . fifth coolant channel, 50 . . . sixth coolant channel, 55 . . . upstream air supply channel, 56 . . . downstream air supply channel, 61 . . . first front outer ring retainer, 62 . . . second front outer ring retainer, 64 . . . front inner ring retainer, 64a . . . axial channel, 65 . . . closing plate, 66 . . . rear inner ring retainer, 67 . . . first rear outer ring retainer, 68 . . . second rear outer ring retainer, 69 . . . sleeve, 69a . . . connecting channel, 69b . . . radial channel, 69c . . . axial channel, 69d . . . protrusion, 69fa . . . outer circumferential surface, 69fb . . . first end face, 69fp . . . first opening, 69e . . . third end face, 71 . . . coil spring, 79 . . . sealer, 82 . . . bolt, 85 . . . opening, 90 . . . control device, 92 . . . air supply device, 93 . . . hydraulic device, 95 . . . coolant supply device, 111 . . . spindle device, 120 . . . air supply channel, 125 . . . third air supply channel, 126 . . . sixth air supply channel, 130 . . . coolant channel, 142 . . . stepped surface, 144 . . . stepped surface, 146 . . . bolt, 148 . . . preload spring, 155 . . . fourth air supply channel, 156 . . . spindle air supply channel, 230 . . . drawbar, 234 . . . front member, 235 . . . rear member, 320 . . . air supply channel, 321 . . . air communication channel, 321A . . . upstream communication channel, 321B . . . one-end channel, 321Bb . . . axial channel, 321Bd . . . downstream portion, 321C . . . downstream communication channel, 327 . . . spindle air supply channel, 328 . . . end channel, 331 . . . upstream end, 337 . . . push rod, 338 . . . rod coolant channel, 355 . . . upstream air supply channel, 356 . . . downstream air supply channel, 355, 382H . . . rod hole, 421Bb . . . radial channel, AX . . . central axis, R2 . . . region

1. A spindle device comprising:
a spindle housing:
a main spindle rotatably supported by the spindle housing and having a tapered hole that is positioned at one end and to which a tool is removably attached, and a spindle cylindrical portion that is positioned on the other end side with respect to the tapered hole and communicates with the tapered hole:
a collet chuck that is disposed inside the spindle cylindrical portion and grips the tool: and
a drawbar that is connected to the other collet end of the collet chuck and moves the collet chuck forward and backward along an axial direction of the main spindle, wherein:
the collet chuck includes
a plurality of claw portions that grips the tool and is arranged in a circumferential direction about a central axis of the main spindle,
a plurality of collet clearances that extends from one collet end forming one end and having an annular shape toward the other end of the main spindle, forms channels that guide air to the tapered hole, and is each a clearance between claw portions among the plurality of claw portions, and
a collet cam surface:
the spindle cylindrical portion has a housing space in which the other collet end is housed in a clamped state:
a defining surface that defines the housing space includes a cam surface that comes into contact with the collet cam surface when the collet chuck moves forward:
the main spindle includes a plurality of spindle air supply channels for supplying air to the housing space in an unclamped state: and
the spindle device further includes an annular channel that communicates upstream sides of the plurality of spindle air supply channels.

2. The spindle device according to claim 1, wherein a relative position of each collet clearance among the plurality of collet clearances with respect to each spindle air supply channel among the plurality of spindle air supply channels is the same.

3. The spindle device according to claim 2, wherein:
the number of the plurality of collet clearances is the same as the number of the plurality of spindle air supply channels; and
the plurality of collet clearances is disposed at equal intervals, and the plurality of spindle air supply channels is disposed at equal intervals.

4. The spindle device according to claim 3, wherein:
the plurality of spindle air supply channels extends along a radial direction of the main spindle; and
phase positions of the plurality of spindle air supply channels and phase positions of the plurality of collet clearances agree with each other.

5. The spindle device according to claim 1, further comprising:
a biasing member that biases the drawbar away from the tapered hole along the axial direction: and
a cylinder device that pushes the drawbar toward the tapered hole in the unclamped state.

6. The spindle device according to claim 1, further comprising:
an inner pipe that is disposed inside the drawbar, and includes one pipe end forming one end, and the other pipe end closer to the other end of the main spindle than the one pipe end:
a pipe air supply channel that is disposed outside the inner pipe and extends from the one pipe end to the other pipe end:
an other-end air channel that is disposed near the other pipe end and causes air to flow into the pipe air supply channel, and through which the air flows inward in a radial direction of the inner pipe:
a one-end air channel that is disposed near the one pipe end and causes air to flow out of the pipe air supply channel, and through which the air flows outward in the radial direction of the inner pipe:
a guide sleeve disposed between the main spindle and the drawbar;
a collet sleeve disposed between the main spindle and the drawbar to adjoin the guide sleeve in the axial direction:
a third air supply channel that is formed by a clearance between the guide sleeve and the drawbar, and communicates with the one-end air channel;
a guide sleeve channel that is formed at one end of the guide sleeve, extends along a radial direction of the guide sleeve, and communicates with the third air supply channel:
a collet sleeve channel serving as the annular channel that is formed between the main spindle and the collet sleeve, communicates with the guide sleeve channel on the other end side, and communicates with the plurality of spindle air supply channels on one end side: and
a coolant channel disposed inside the inner pipe.

7. The spindle device according to claim 1, further comprising:
an air communication channel that is formed on an outer side in a radial direction with respect to the spindle air supply channels, and through which air from an outside is supplied to the spindle air supply channels; and
a front bearing that is disposed at a position near the one end of the main spindle in the axial direction, and rotatably supports the main spindle, wherein the air communication channel includes a one-end channel that is positioned on the one end side with respect to the front bearing in the axial direction, and is formed in the spindle housing and the main spindle.

8. The spindle device according to claim 7, wherein:
the spindle housing includes a first end face having a first opening constituting the one-end channel:
the main spindle includes a second end face that has a second opening constituting the one-end channel, and faces the first end face in the axial direction; and
the one-end channel includes an axial channel that includes the first opening and the second opening, and extends in the axial direction.

9. The spindle device according to claim 8, wherein:
the spindle housing includes a sleeve surrounding the main spindle about the axial direction:
the sleeve includes an outer circumferential surface, the first end face, and a third end face protruding from the outer circumferential surface:
the spindle housing further includes a fourth end face that faces the third end face in the axial direction: and
the spindle device further includes a sealer that is disposed between the third end face and the fourth end face, and is compressed in the axial direction in the unclamped state to bias the sleeve toward the second end face.

10. The spindle device according to claim 9, wherein:
the main spindle further includes a spindle cap forming the tapered hole:
the spindle housing further includes a front cap constituting one housing end of the spindle housing: and
the one-end channel is formed in the spindle cap and the front cap.

11. The spindle device according to claim 10, wherein:
the main spindle includes
a cap small diameter portion positioned on a radially inner side of the spindle housing, and
a cap large diameter portion that is positioned on the other end side with respect to the cap small diameter portion in the axial direction, and has a larger outside diameter than the cap small diameter portion: and
the second end face is formed in the cap large diameter portion.

12. The spindle device according to claim 8, further comprising:
a biasing member that biases the drawbar away from the tapered hole along the axial direction: and
a cylinder device that pushes the drawbar toward the tapered hole in the unclamped state, wherein
the first end face and the second end face are separated from each other in the clamped state, and
the second end face comes into contact with the first end face in the unclamped state.

13. The spindle device according to claim 10, further comprising a retaining plate that is attached to the front cap, and includes the fourth end face.

14. The spindle device according to any one of claims 7 to 13, wherein:
the spindle housing includes a one-end housing inner circumferential surface having an inner circumferential surface opening constituting the one-end channel:
the main spindle includes a one-end spindle outer circumferential surface having an outer circumferential surface opening constituting the one-end channel:
the outer circumferential surface opening is disposed at a position where the outer circumferential surface opening faces the inner circumferential surface opening in the radial direction in the unclamped state: and
the one-end channel includes a radial channel that includes the inner circumferential surface opening and the outer circumferential surface opening, and extends in the radial direction in the unclamped state.
